(19) United States
(12) Patent Application Publication
(10) Pub. No.: US 2023/0244927 A1
(43) Pub. Date: Aug. 3, 2023

(54) USING CNN IN A PIPELINE USED TO FORECAST THE FUTURE STATUSES OF THE TECHNOLOGIES

(71) Applicant: Dell Products L.P., Round Rock, TX (US)

(72) Inventors: Mohamed Ahmed Amr Abouzeid, Cairo (EG); Osama Taha Mohamed Abdelbaky, Cairo (EG); Yaseen Tamer Refaie Moussa, Cairo (EG); Hany Adel Michel Moussa, Cairo (EG)

(21) Appl. No.: 17/646,593

(22) Filed: Dec. 30, 2021

(51) Int. Cl. G06N 3/08; G06K 9/62

(52) U.S. Cl. CPC G06N 3/08; G06K 9/6223; G06K 9/6257

(57) ABSTRACT

One example method includes obtaining data from one or more databases of information about one or more technologies, selecting a set of features for extraction from the data, extracting the features from the data, and using a convolutional neural network to generate a forecast for the features, and the forecast is made with respect to a defined time period. The forecast may indicate the expected lifecycle changes of the features over the defined period of time.

### FIELD OF THE INVENTION

Embodiments of the present invention generally relate to generating predictions as to future status of technologies. More particularly, at least some embodiments of the invention relate to systems, hardware, software, computer-readable media, and methods for accessing scientific literature and using information in the scientific literature to identify a current status, and a future predicted status, of one or more technologies.

### BACKGROUND

Companies are investing millions of dollars annually on new technologies and, thus, these companies are trying to use different approaches to help ensure that they are investing in the right technology at the right time. The purpose of this approach is to find a good fit between the technology and the company, and to reduce the likelihood that the company will invest in technology that is not a good fit, or becomes obsolete too quickly. Currently however, there is no systematic way that guarantees that these companies are investing in the right technology.

A particular problem is the current inability to forecast a technology maturity phase of a technology, that is, the inability to forecast when a particular technology will reach maturity.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a comparison of a forecast made by a convolutional neural network with actual outcomes.

FIG. 2 discloses a graph illustrating the outcome of a clustering operation performed using the elbow method.

FIG. 3 discloses various charts showing forecasts generated according to some embodiments, and actual outcomes, of feature changes, from patents, over a period of time.

FIG. 4 discloses various charts showing forecasts generated according to some embodiments, and actual outcomes, of feature changes, from technical papers, over a period of time.

FIGS. 5a and 5b disclose various charts showing forecasts generated according to some embodiments, and actual outcomes, of feature changes, from both technical papers and patents, over a period of time.

FIG. 6 discloses an example method according to some embodiments.

FIG. 7 discloses aspects of an example computing entity operable to perform any of the disclosed methods, processes, and operations.

### DETAILED DESCRIPTION OF SOME EXAMPLE EMBODIMENTS

Embodiments of the present invention generally relate to generating predictions as to the future status of technologies. More particularly, at least some embodiments of the invention relate to systems, hardware, software, computer-readable media, and methods for accessing scientific literature and using information in the scientific literature to identify a current status, and a future predicted status, of one or more technologies.

In general, example embodiments of the invention may operate to forecast when a particular technology is expected to reach one or more particular phases, such as Wardley map phases for example, in its lifecycle. To this end, example embodiments may include a data collection phase that may involve accessing various datasets of open source technical literature. The collected data may be normalized, or otherwise processed, to account for different terms and usages employed in describing the technologies. Next, a CNN (convolutional neural network) may be used to forecast feature values each of the technologies is expected to reach one or more particular lifecycle phases. Finally, the technologies may then be clustered together according to the forecasted feature values.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that an enterprise may be able to determine a lifecycle phase of a technology in use by the company. An embodiment may enable an enterprise to predict when a particular technology will reach a particular lifecycle phase. An embodiment may enable an enterprise to make informed decisions about (i) when to transition from an older technology to a new technology, and about (ii) what new technology to invest in. Various other advantageous aspects of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

In the rapidly changing technology and innovation world, there is a persistent need to prepare for the circumstances of the future. One way to achieve this, following scientific and mathematical discourse, is to create models, such as machine learning models, that attempt to explain the current system, and then extrapolate, based on that model, predictions about the future of the system. This process can be rigorous, and therefore starts with defining the scope. Thus, example embodiments may operate to model the status of a technology through modeling data that partially describes aspects, or data features, about the status/state of the technology. One modeling technique that may be employed by example embodiments of the invention is a forecasting model, such as CNN for example, which may be used to model the historical data, such as the previous 10 years for example, of the features, and then predict how the technology may develop, for example, over the next five years into the future. The model may then output the technologies in classes/groupings, each of which may be mapped to a particular lifecycle phase of a Wardley map.

In more detail, example embodiments may use the Wardley mapping technique that defines technologies to be in one of various phases, namely, genesis, custom build, product, or commodity. With this mapping technique, embodiments may create a status label for each technology. After obtaining the cluster output from a clustering algorithm, such as the K-Means algorithm for example, embodiments may operate to draw a connection or correspondence between the final clusters of feature-data, and one of the phases in the Wardley map. In this way, embodiments may be able to generate a prediction as to when, in the future, a particular technology will reach a particular lifecycle status, or maturity phase. As well, embodiments of the invention may be able to identify a current lifecycle phase of a technology.

### B. Detailed Aspects of Some Example Embodiments

At least some example embodiments of the invention are generally directed to the process of predicting the future status of technologies through a data-driven methodology that uses a hybrid of models in conjunction with open-source data. Embodiments may employ unsupervised clustering algorithms, in correspondence with a Wardley mapping technique, to estimate a current conceptual status, or lifecycle phase, of specified technologies. To that end, example embodiments may use a CNN model to predict the near future features of the technologies, and then use a K-means model to cluster the technologies into five different clusters. This model may then be used to make predictions about the near future of these technologies, where each cluster is identified through a reordering algorithm and presents the phase of the technology in the corresponding year.

Further to the foregoing discussion, example embodiments may employ a pipeline which may utilize external, publicly available, technology related datasets collected from different open source data sources to produce reliable predictions on the future statuses of the technologies in the next five years. This pipeline may use three machine learning models to predict the future statuses of the technologies. These three models are discussed in detail in the coming sections. Example embodiments may operate to classify technologies into four main categories based on the Wardley convention discussed above.

The first machine learning model used in example implementations of such a pipeline is a Computer Science Ontology Classifier (CSO). This model may be used for data preparation purposes. This classifier is configured to apply an unsupervised learning approach for automatically classifying research papers according to the Computer Science Ontology (CSO), a comprehensive ontology of research areas in the field of computer science. Embodiments of the invention may employ this approach as an automated way to analyze data, such as patents, research papers, and other technical information, and to map the content of such materials to specific technologies listed in the CSO. The CSO classifier may also ensure that technology names are unified across the different data sets, so as to enable preparation of the data for the same technologies in the training process. As well, the classifier may also help to map the labels from the various data sources into their corresponding feature sets from the papers and patents datasets. This may be done, for example, by feeding all the abstracts of the papers and patents into multiple CSO terms and aggregating the features across these sets.

As noted, embodiments of the invention may implement a pipeline that employs three models, one of which is the CSO. Example embodiments may additionally employ, as part of the pipeline, CNN as a forecasting model to predict the future values for all the available features. Finally, example embodiments may cluster the forecasted data into the four Wardley map phases using K-means clustering algorithm. Thus, example pipelines according to some embodiments may employ a CSO model, a CNN forecasting model, and a clustering model, or clustering algorithm.

### B.1 Datasets

Example embodiments may implement a data-driven approach to forecasting. For example, embodiments may operate to collect data from multiple sources, which may be open sources, into one dataset, and then use that dataset as a basis for making predictions as to the future of various technologies. Example embodiments may construct a dataset from open-source datasets available online. As used herein, open-source datasets refer to datasets that make available technical information publicly online, such as technical papers or US patent information. Example open-source datasets may include the arXiv academic papers, and Google US Patents datasets. Data from such datasets may be collected for a particular period of time, such as starting from 2010 through the present. After the data has been collected, the CSO classifier may determine the category of each paper and patent. After that, a group of data features, or attributes, may be extracted from each dataset that describe these technologies, and the extracted features may be combined to form a dataset. For each feature, several data points, such as readings or observations for example, may be recorded in a time-series fashion, with one value per set amount of time. Some example features include, but are not limited to, the rate of change of arXiv paper citations, the rate of change of Google US Patent citations, and the z-score of arXiv and patents citation count. These example features are discussed in more detail below.

### B.2 Features

In order to capture as much information as possible from the patents, and patent publications, example embodiments may employ a variety of features. Example features include, but are not limited to:
num_patents: The number of patents filed in every technology for every year;
sum_fwd_citations_patents: The sum of the forward citations of all patents in a certain technology for every year. As used herein, forward citation refers to the number of times a patent has been cited after it has been made public;
sum_bck_citations_patents: The sum of the backward citations of all patents in a certain technology for every year. As used herein, backward citation refers to the number of patents cited by a specific patent;
sum_fwd_z_patents: The z-score of the technology in every year based on its value of sum_fwd_citations_patents. Z-Score is an especially useful statistic because it provides a metric to describe classes invariant of time limitations;
sum_bck_z_patents: The z-score of the technology in every year based on its value of sum_bck_citations_patents; and
sum_num_inventors_patents: The total number of inventors in all patents targeting a certain technology; for example on a yearly basis.

For academic papers, features used may include, but are not limited to:
num_papers;
sum_fwd_citations_papers;
sum_bck_ciations_papers;
sum_num_authors_papers sum_fwd_z_papers; and
sum_bck_z_papers. Such features may be calculated in a similar fashion to that of the patents described above.

### B.3 Forecasting

One aim of pipelines according to some example embodiments is to determine the Wardley map stage of a technology at a specific year, utilizing the features of the technology for that year. So, for example, given various Artificial Intelligence (Al) features such as, for example, number of patents, number of papers, backward_z-score, and forward_z-score, for 2018, an embodiment may then determine the corresponding present Wardley map stage, or lifecycle stage, of Al. However, this introduces a challenge for future years. Particularly, because the aforementioned example correspond to present data, forecasting the future values of these features may improve performance of example embodiments.

In example embodiments, the CNN model may operate to forecast the papers and patents features in a multivariate sense, that is, forecast all features concurrently, for a pre-determined number of years in the future. Conventionally, assessing the performance of such model could be problematic since no ground truth exists against which future forecasts can be compared. For this reason, example embodiments may employ a supervised approach for evaluating the model, meaning that, while training, forecasts may also be used as past, or historical, data. In this way, the forecasts may serve as ground truth. To illustrate, suppose that there exists nine years of data (2010-2018) for every technology and, while training, the first six years of data (2010-2015) are used for model training, and the following three years of data (2016-2018) are used for testing/evaluation.

The error metric used in some example embodiments is the Root Mean Square Error (RMSE), which may be expressed as:

$$R M S E = \sqrt{\frac{{\sum }_{i = 1}^{N} {\left({y}_{{\left(a c t u a l\right)}_{i}} - {y}_{{\left(p r e d i c t e d\right)}_{i}}\right)}^{2}}{N}}$$

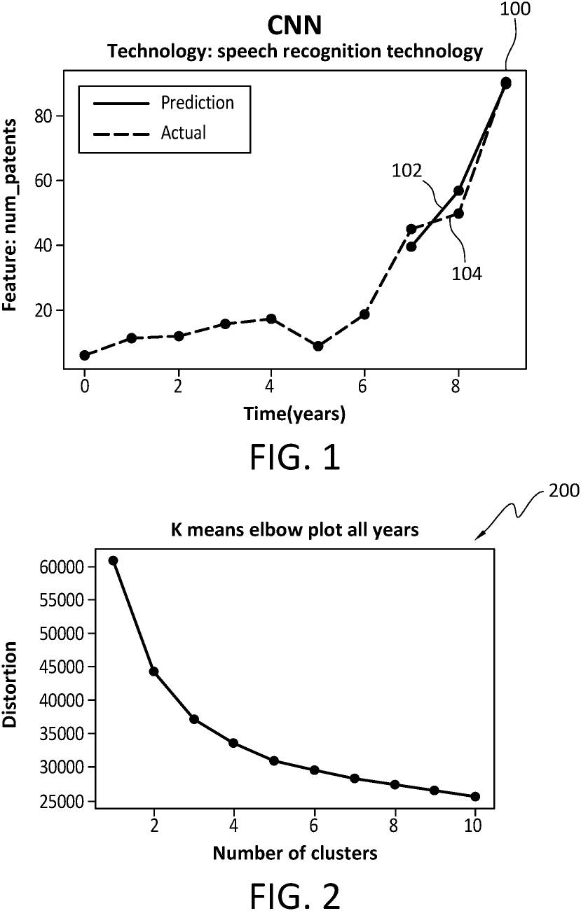

In this case, ‘N’ stands for the number of test technologies, and ‘y’ is a feature value. Based on the reliability of the model forecasting these values, the potential performance of the model on future data is assessed. An illustration of the prediction for the number of patents for speech recognition technology is shown in FIG. 1. As indicated in the graph 100 in FIG. 1, the prediction 102 for the number of speech recognition technology patents issued tracks fairly closely with the actual 104 number of speech recognition patents issued.

Embodiments of the invention may provide for the use of unsupervised forecasting models. In one illustrative example of the operation of some embodiments, a model may receive, as input, data for the six years 2013-2018, and the model may then use that data to predict three years into the future, that is, for the three years 2019-2021. Because the data for all the past years 2013-2021 is known, the data for years 2013-2018 can be taken as ground truth, and used to make a test prediction for the years 2019-2021. The test prediction for 2019-2021 can then be compared with the actual data from those years to assess the accuracy of the model in making the prediction. Another level of forecasting may also be applied by utilizing the known 2016-2021 data as a basis to forecast the unknown data for the papers and patents features, for example forecasting 2022-2024 data when those years have not yet occurred at this time.

It is noted that although the example approach referred to above utilizes a 6-3 window in which 6 of the 9 years of data are used to make predictions about the following 3 years, other configurations may be employed, such as 6-2, 7-2, or 5-3, for example. There may be some tradeoff between the forecast reliability and the number of cascading forecasts in the future. To illustrate, the 7-2 window was determined, during experimentation, to be promising but the fact that only 2 years were predicted meant that 3 levels of forecasts had to be cascaded to forecast up to 2024, possibly introducing cascaded errors in the predictions. In some implementations at least, the 6-3 window produced the best results in terms of root-mean-squared-error (RMSE) for the forecasts, while at the same time providing a window large enough to enable the prediction of 6 years into the future while relying only once on the forecasted data to make the prediction. Table 1 below illustrates a comparison of the experimental performance of various forecasting algorithms.

TABLE 1

Comparison between RMSE, train, and test times per algorithm

| Algorithm | RMSE (unscaled different features) | Time(s) | |
|---|---|---|---|
| | | Train | Test |
| VAR | 16345 | NA | 1111 |
| LSTM | 4844 | 1715 | 1.1 |
| CNN | 4321 | 401 | 0.21 |

### B.4 Clustering

Embodiments may employ unsupervised clustering algorithms, in connection with a Wardley mapping technique, to estimate a current conceptual status, or lifecycle phase, of specified technologies. An output of this process may be a Wardley mapping of each of the technologies, where the technologies are clustered together, in a Wardley map, based on where those technologies are in their respective lifecycles.

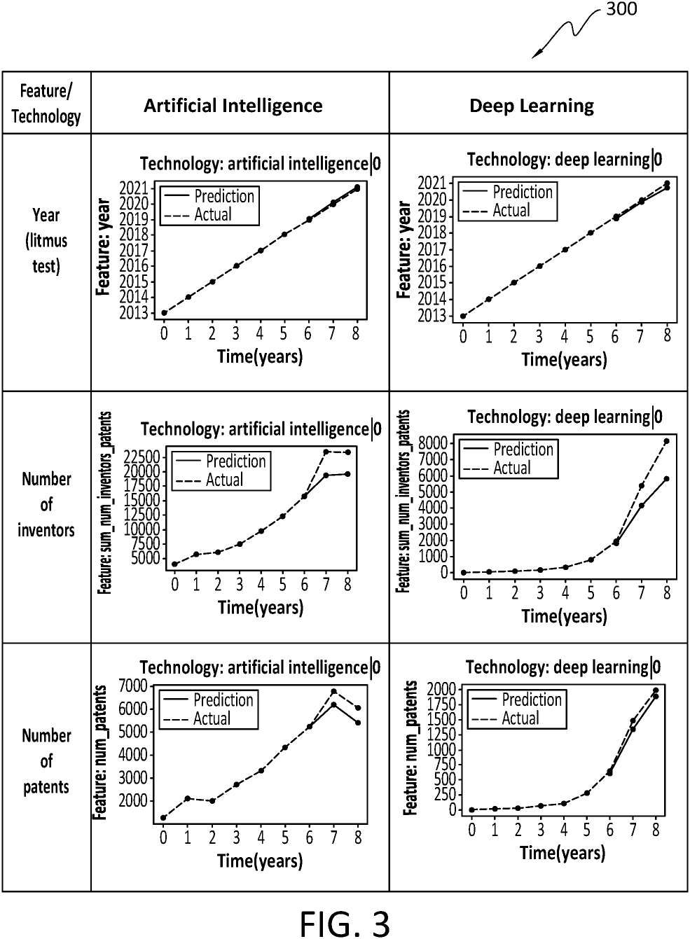

Clustering may be performed in various ways, using various algorithms. Some example embodiments of the invention may employ K-means clustering to cluster the technologies according to lifecycle phase. K-means clustering is an unsupervised algorithm that aims to partition n observations into k clusters, where observations in the same cluster are determined or inferred to be related to each other in some way. In order to find an appropriate number of clusters, the elbow method may be used. As shown in the graph 200 of FIG. 2, the elbow method, in some experiments, indicated an optimal number of 4-5 clusters for at least some example embodiments.

In short, the k-means clustering model may be able to use the features, such as number of patents, number of papers, z-score of each technology in a certain year, for example, to identify at which stage of the Wardley map the technology is at. K-means clustering provides numerical clustering so in order to map such clusters to the Wardley map stages, embodiments may identify and explore patterns in the features within each cluster to determine the cluster label.

### C. Further Discussion

While various conventional approaches exist for technology forecasting, those conventional approaches typically require historical labels for the position of the technology, which would include several biases on the selection of this label for each technology, as well as issues with the predictions of new technologies arising in the future. In contrast, example embodiments of the invention may forecast the features and then use an unsupervised clustering algorithm to forecast the prospects of a given technology in the future.

Another example of advantages of some embodiments is apparent when comparing such embodiments to conventional approaches involving the use of growth curves to make conclusions about the lifecycle of a technology. In contrast, example embodiments may operate to capture relationships between features, which is not attainable with growth curves, as they are typically fitted for univariate data, rather than multivariate data as in the case of example embodiments of the invention.

As a final example, conventional approaches that employ statistical models such as vector autoregression (VAR) to forecast the features are not well suited for forecasting over long periods of time. Nor are such conventional approaches able to effectively handle big data. On the other hand, example embodiments may employ a neural network architecture, which utilizes a large amount of data available to forecast papers and patents features. To illustrate, example embodiments may operate to make effective predictions for as many as 5000, or more, different technologies for time periods of 10 years, or more.

### D. Example Experimental Results

The inventors conducted multiple experiments to show how the CNN could be of value when it comes to multivariate forecasting. In the first experiment, the inventors utilized patents features only, performed feature forecasting and compared against the ground truth values. In the second experiment, the inventors utilized papers features only, in a similar fashion to that of the patents feature forecasting. Additionally, a comprehensive dataset using both patents and papers data was used, compared against the first 2 experiments to re-verify the multivariate ability of CNNs for forecasting. All the previous experiments were trained using 5114 technologies, each having features across the years: 2010-2018 (inclusive). In all cases, 6 years were used for training and 3 years were used for testing. Finally, a comparison between the CNNs and the previously used forecasting methods is provided outlining the performance boost in training time, testing time as well as lower root-mean-squared-errors RMSEs.

### D.1 Predicting Features of Patents

In this experiment, the following features were used for every technology in every year:
num_patents: The number of patents filed in every technology for every year.
sum_fwd_citations_patents: The sum of the forward citations of all patents in a certain technology for every year.
sum_bck_citations_patents: The sum of the backward citations of all patents in a certain technology for every year.
sum_fwd_z_patents: The z-score of the technology in every year based on the value of its sum_fwd_citations_patents.
sum_bck_z_patents: The z-score of the technology in every year based on the value of its sum_bck_citations_patents.
sum_num_inventors_patents: The total number of inventors in all patents targeting a certain technology.
year: This feature is used as a litmus test to make sure that the predictions are making sense. In this case, year is supposed to increase linearly (by 1 every year), and this should be an easy way to determine if the model is not making sense. Note that the value of a year does not necessarily reflect the present year. The ‘year’ feature range was large to make sure that the model does not memorize the predictions (current year, current year + 1, current year + 2).

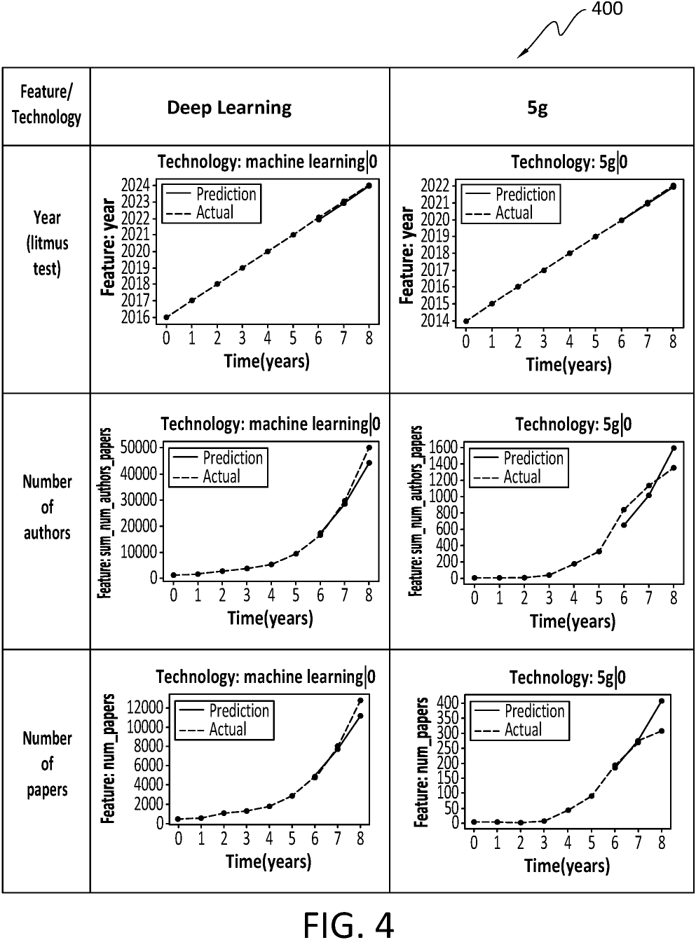

As can be seen in the chart 300 of FIG. 3, the model has learned the different patterns in the data distribution, in a multivariate sense, and successfully forecasted the different features simultaneously, e.g., concurrently, with a great level of accuracy. Additionally, the litmus test was passed by predicting the ‘year’ feature almost perfectly.

### D.2 Predicting the Features of Papers

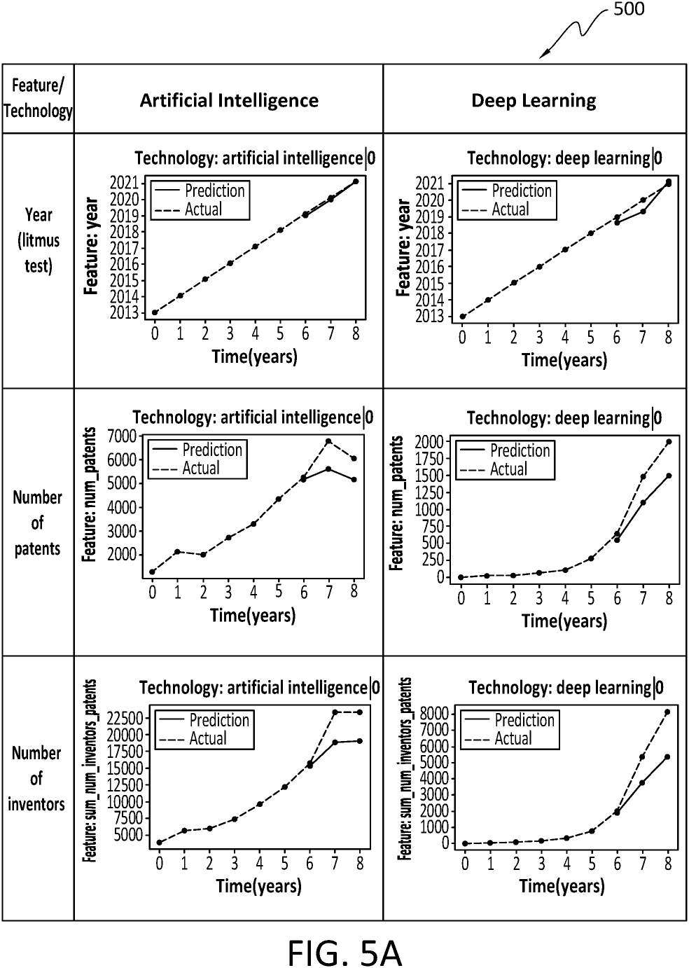

Turning next to FIG. 4, the chart 400 includes sample results of predicting papers features. In general, the experiment that produced the results in chart 400 was quite similar to the experiment that produced the results in the chart 300, except that in the case illustrated in FIG. 4, only features of papers were considered, while in the case illustrated in FIG. 3, only features of patents were considered. The features employed in both experiments were quite similar but were calculated, in the case of the results in the chart 400, based on arXiv papers. As in the case of the experiment performed using features of patents (FIG. 3), the model has, again, learned the data distribution and successfully predicted the paper feature values with an acceptable level of accuracy (FIG. 4).

### D.3 Predicting the Features of Both Papers and Papers

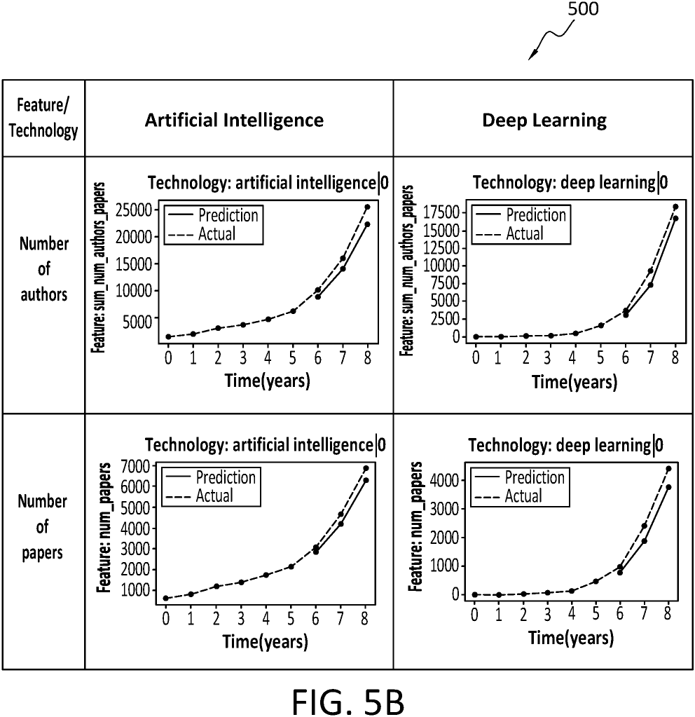

In this experiment, both papers and patents features were used concurrently to train the CNN model and the results are shown in the chart 500 of FIGS. 5a and 5b, which includes sample results of predicting papers and patents features.

Using features of both patents and papers, it is clear from the chart 500 that the forecasts are also highly accurate. In addition, it can be seen that the forecasts are quite similar to those predicted using patents features only in experiment 1 (chart 300 shown in FIG. 3) and those using papers features only in experiment 2 (chart 400 shown in FIG. 4). Furthermore, these experimental results demonstrate the capability of CNN to perform multivariate forecasting using some relatively unrelated features, that is, of patents and papers.

### D.4 Comparison Between CNN, LSTM and VAR

The inventors have also investigated multiple forecasting methods, namely VARs, LSTMs and CNNs, a comparison of which is shown in the Table 2 below. As shown, CNN exhibited superior training as well as testing time. The inventors also conducted an experiment with over 2000 technologies. In addition, the inventors utilized the average root-mean-squared-error (RMSE) for the forecasts of the test technologies as the evaluation metric. The CNN model outperformed both VAR and LSTM models as well, having the lowest RMSE.

TABLE 2

| Algorithm | RMSE (unscaled different features) | Time(s) | |
|---|---|---|---|
| | | Train | Test |
| VAR | 16345 | NA | 1111 |
| LSTM | 4844 | 1715 | 1.1 |
| CNN | 4321 | 401 | 0.21 |

### E. Example Methods

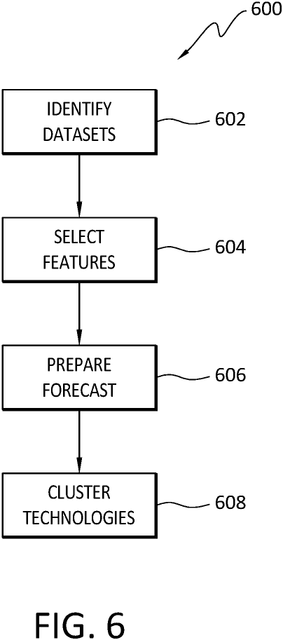

It is noted with respect to the example method of FIG. 6 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 6, an example method 600 is disclosed. The method 600 may be performed by a single computing entity, comprising hardware/and or software, or may be cooperatively performed by multiple computing entities, each comprising hardware and/or software. As an example of the latter case, the example pipelines disclosed herein may comprise a respective computing entity for implementing each of the models employed. Further, while example algorithms and models are disclosed herein as performing operations which may be included in the method 600, the scope of the invention is not limited to the use of any particular algorithm, model, or combination of these. As well, the method 600 may be performed with respect to multiple different technologies. For example, the method 600 may be employed to assess multiple technologies all at the same time, or multiple technologies may be analyzed in serial fashion one after the other.

The example method 600 may begin with identification and accessing 602 of one or more datasets that contain technical information, such as trends in technology and technological developments for example, that may be useful for the purposes of preparing technology forecasts for one or more types or fields of technology. One or more of the datasets may, or may not, be open source datasets that are generally accessible to the public. In some instances, one or more datasets may be proprietary, such as to a business enterprise or government entity for example.

After accessing 602 the datasets, the datasets may be analyzed and various features selected 604 from those datasets. In general, the features may be those deemed to be indicative of trends and developments in one or more technical fields, and, more generally, any information in the datasets that may lend itself for use in determining the current state, or lifecycle phase, of a technology and/or in forecasting when a technology may reach future phases of its lifecycle.

Using the selected 604 features, a forecast may then be prepared 606 concerning one or more technologies of interest. The forecast, which may predict changes in the extracted features over a defined period of time, may identify, or be used to identify, a current state, or lifecycle phase, of a technology and/or may predict when, and how quickly, a technology is expected to reach the future phases of its lifecycle. The forecast may be used as a basis for investing in, or avoiding the use of, one or more technologies. As another example, the forecast may be used to determine when, and how quickly, a transition should be made from an older technology, such as a legacy technology, to a new technology.

After a forecast has been made 606, and/or after a determination has been made as to the current lifecycle phase of a technology, or technologies, the technologies may then be clustered 608 according the lifecycle phase they are currently in. This clustering may be performed with respect to the Wardley lifecycle phases by identifying, for each technology, the current Wardley lifecycle phase of that technology. Further, because forecasts have been prepared 606 for the various technologies, still other Wardley mappings may be created that cluster technologies according to when those technologies are expected to enter one or more future lifecycle phases. For example, all technologies expected to enter a ‘commodity’ phase during a particular timeframe could be grouped together on that basis.

Still other analyses may be performed based on one or more forecasts. For example, the technologies may be evaluated to determine how quickly they move from one lifecycle phase to one or more other lifecycle phases. The technologies could be clustered together based on the speed with which they move through their respective lifecycles, or portions of the respective lifecycles. Various other possibilities for analysis, forecasting, and clustering, will be apparent from this disclosure.

While not specifically indicated in the example of FIG. 6, the method 600 may be performed on a recursive basis based on developments in the applicable fields. Such developments may include, for example, changes in the content of the datasets, additions/modifications/deletions to dataset features that are extractable, improvements in clustering methodologies, and improvements in forecasting methodologies.

### F. Further Example Embodiments

Following are some further example embodiments of the invention. These are presented only by way of example and are not intended to limit the scope of the invention in any way.

Embodiment 1. A method, comprising: obtaining data from one or more databases of information about one or more technologies; selecting a set of features for extraction from the data; extracting the features from the data; and using a convolutional neural network to generate a forecast for the features, and the forecast is made with respect to a defined time period.

Embodiment 2. The method as recited in embodiment 1, wherein the forecast is used to determine a respective current lifecycle phase for one or more of the technologies.

Embodiment 3. The method as recited in embodiment 2, wherein the lifecycle phase is a Wardley map lifecycle phase.

Embodiment 4. The method as recited in any of embodiments 1-3, wherein the databases are open source databases that include patents and/or technical literature.

Embodiment 5. The method as recited in any of embodiments 1-4, wherein the forecast is made for all of the features concurrently.

Embodiment 6. The method as recited in any of embodiments 1-5, wherein the convolutional neural network is trained using a first set of historical data to generate a model forecast, and the model forecast is compared to a second set of historical data that is later in time than the first set of historical data.

Embodiment 7. The method as recited in any of embodiments 1-6, wherein the forecast indicates, for each of the features, how that feature is expected to change during the defined time period.

Embodiment 8. The method as recited in any of embodiments 1-7, wherein the forecast for the features indicate when one or more technologies are expected to change from a first lifecycle phase to a second lifecycle phase during the defined time period.

Embodiment 9. The method as recited in any of embodiments 1-8, further comprising clustering the technologies based on their respective current lifecycle phase.

Embodiment 10. The method as recited in embodiment 9, wherein the technologies are clustered using a k-means clustering algorithm.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

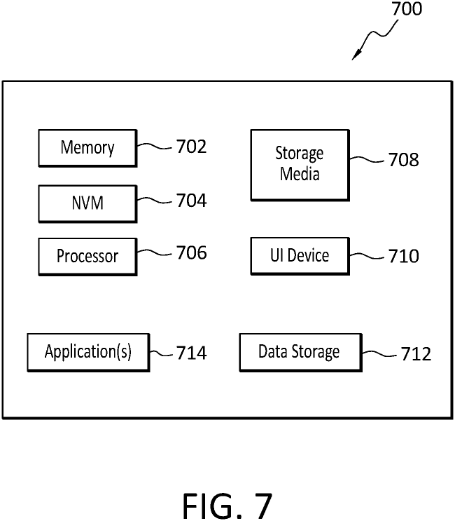

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
obtaining data from one or more databases of information about one or more technologies;
selecting features for extraction from the data;
extracting the features from the data; and
using a convolutional neural network to generate a forecast for the features, and the forecast is made with respect to a defined time period.

2. The method as recited in claim 1, wherein the forecast is used to determine a respective current lifecycle phase for one or more of the technologies.

3. The method as recited in claim 2, wherein the current lifecycle phase is a Wardley map lifecycle phase.

4. The method as recited in claim 1, wherein the databases are open source databases that include patents and/or technical literature.

5. The method as recited in claim 1, wherein the forecast is made for all of the features concurrently.

6. The method as recited in claim 1, wherein the convolutional neural network is trained using a first set of historical data to generate a model forecast, and the model forecast is compared to a second set of historical data that is later in time than the first set of historical data.

7. The method as recited in claim 1, wherein the forecast indicates, for each of the features, how that feature is expected to change during the defined time period.

8. The method as recited in claim 1, wherein the forecast for the features indicate when one or more of the technologies are expected to change from a first lifecycle phase to a second lifecycle phase during the defined time period.

9. The method as recited in claim 1, further comprising clustering the technologies based on their respective current lifecycle phase.

10. The method as recited in claim 9, wherein the technologies are clustered using a k-means clustering algorithm.

11. A non-transitory storage medium having stored therein instructions that are executable by one or more hardware processors to perform operations comprising:
obtaining data from one or more databases of information about one or more technologies;
selecting features for extraction from the data;
extracting the features from the data; and
using a convolutional neural network to generate a forecast for the features, and the forecast is made with respect to a defined time period.

12. The non-transitory storage medium as recited in claim 11, wherein the forecast is used to determine a respective current lifecycle phase for one or more of the technologies.

13. The non-transitory storage medium as recited in claim 12, wherein the lifecycle phase is a Wardley map lifecycle phase.

14. The non-transitory storage medium as recited in claim 11, wherein the databases are open source databases that include patents and/or technical literature.

15. The non-transitory storage medium as recited in claim 11, wherein the forecast is made for all of the features concurrently.

16. The non-transitory storage medium as recited in claim 11, wherein the convolutional neural network is trained using a first set of historical data to generate a model forecast, and the model forecast is compared to a second set of historical data that is later in time than the first set of historical data.

17. The non-transitory storage medium as recited in claim 11, wherein the forecast indicates, for each of the features, how that feature is expected to change during the defined time period.

18. The non-transitory storage medium as recited in claim 11, wherein the forecast for the features indicate when one or more of the technologies are expected to change from a first lifecycle phase to a second lifecycle phase during the defined time period.

19. The non-transitory storage medium as recited in claim 11, further comprising clustering the technologies based on their respective current lifecycle phase.

20. The non-transitory storage medium as recited in claim 19, wherein the technologies are clustered using a k-means clustering algorithm.
